(19) United States
(12) Patent Application Publication
(10) Pub. No.: US 2012/0072827 A1
(43) Pub. Date: Mar. 22, 2012

(54) INFORMATION PROCESSING APPARATUS, PAGE DESCRIPTION METHOD, AND STORAGE MEDIUM

(75) Inventor: Naohiro Isobe, Kawasaki-shi (JP)

(73) Assignee: CANON KABUSHIKI KAISHA, Tokyo (JP)

(21) Appl. No.: 13/203,615

(22) PCT Filed: Jul. 8, 2011
(86) PCT No.: PCT/JP2011/003936

§ 371 Date: Aug. 26, 2011

(30) Foreign Application Priority Data
Jul. 13, 2010 (JP) 2010-158821

(51) Int. Cl. G06F 17/00

(52) U.S. Cl. 715/234

(57) ABSTRACT

An information processing apparatus calculates, for each object, a parameter from page description information that describes a plurality of pieces of object information each defining a group parameter applied to a group to which an object provided to a plurality of pages in common belongs and defining an individual parameter applied to the object, wherein the group parameter and the individual parameter are merged into the parameter. The apparatus generates shared information defining the calculated parameter and generates the page description information in which the shared information is referred to.

### TECHNICAL FIELD

The present invention relates to an information processing apparatus, a page description method, and a storage medium.

### BACKGROUND ART

In a document with Variable Data Printing (VDP), fixed parts and variable parts are configured to be divided, and data in the variable parts are provided from a data source. In the Variable Data Printing, a column (field) of a data source is associated with variable parts of a template document, and applied to each row (record) of the data source to perform printing of different content for each record unit. Here, a group of logical information such as a page layout and a data source needed for VDP is referred to as a VDP document, and digital data of the VDP document is referred to as VDP data. In addition, an application and a system for creating VDP data are referred to as a VDP data generation system, and an application and a system for performing interpretation processing of VDP data and outputting the VDP data by a digital printing machine are referred to as a VDP data processing system.

In VDP data, mainly, VDP-dedicated Page Description Language (PDL) is used because, in the VDP-dedicated PDL, description can be made in which an object of fixed parts of a VDP document (hereinafter, referred to as “fixed object” as appropriate) is preliminarily defined and the fixed object is referred to later. When the printing processing is performed to such PDL in the VDP data processing system, an interpretation processing result of each of the fixed objects is held and the interpretation processing result has only to be copied each time the fixed object is referred to. Accordingly, it is expected that the whole processing speed of the VDP data is improved. That is, VDP-dedicated PDL has an ability to represent a VDP document in which the VDP data processing system performs processing in an efficient manner.

However, in the VDP data processing system, generally, VDP data generated by the VDP data generation system is processed based on a specification of the PDL, so that the efficiency depends on content of description of the VDP data. Thus, it is important to create VDP data so as to perform processing in an efficient manner in the VDP data processing system, however, VDP data in which processing can be performed in an efficient manner in the VDP data processing system is not necessarily created in the VDP data generation system. Concerning the above-described problem, there has been proposed a method in which cost for drawing processing of each object is preliminarily calculated, regards the object as a fixed object when the cost for drawing processing is high, and newly creates Personalized Print Markup Language (PPML) data regarded as a variable object when the cost thereof is low (for example, PTL 1). Here, PPML is XML-based VDP-dedicated PDL that is developed by an industry group (Print On Demand initiative (PODi)) that promotes digital printing.

In addition, there has been proposed a method in which VDP data created as Portable Document Format (PDF) is converted into a PPML template format (for example, PTL 2). The PPML template is also PDL that is developed by PODi. The PPML template can include a template in PPML and a data source therein, and a processing system compatible with PPML template can generate PPML data using the template in PPML and the data source.

In addition, in VDP data to be used as PPML, there has been proposed a method in which a plurality of pieces of object data is merged as single Post Script data to reduce overhead of processing of object data (for example, PTL 3).

However, in the methods described in PTL 1 and PTL 3, optimization in consideration of relation between a plurality of objects cannot be realized. In addition, in the method described in PTL 2, the processing system compatible with PPML template is needed, however, there is a problem that the processing system compatible with PPML template is not in widespread use.

The present invention has been made in view of the problems described above, an aim of the invention is to enhance efficiency of processing for dealing with an object provided to plurality of pages in common.

### CITATION LIST

### Patent Literature

PTL1: Japanese Patent Application Laid-Open No. 2007-072674

PTL2: Japanese Patent Application Laid-Open No. 2005-166050

PTL3: Japanese Patent Application Laid-Open No. 2005-210395

### SUMMARY OF INVENTION

In order to solve the problems discussed above, the present invention provides with an information processing apparatus that calculates, for each object, a parameter from page description information that describes a plurality of pieces of object information each defining a group parameter applied to a group to which an object provided to a plurality of pages in common belongs and defining an individual parameter applied to the object, wherein the group parameter and the individual parameter are merged into the parameter. The information processing apparatus then generates shared information defining the calculated parameter and generates the page description information in which the shared information is referred to.

Further features of the present invention will become apparent from the following description of exemplary embodiments with reference to the attached drawings.

### BRIEF DESCRIPTION OF DRAWINGS

FIG. 1A is diagram illustrating an example of a configuration of VDP data according to a VDP document.

FIG. 1B is diagram illustrating an example of a configuration of VDP data according to a VDP document.

FIG. 2A is diagram conceptually illustrating various parameters.

FIG. 2B is diagram conceptually illustrating various parameters.

FIG. 2C is diagram conceptually illustrating various parameters.

FIG. 3 is a diagram illustrating an example of a hardware configuration of an the information processing apparatus.

FIG. 4A is diagram illustrating an example of drawing description in PPML.

FIG. 4B is diagram illustrating an example of drawing description in PPML.

FIG. 4C is diagram illustrating an example of drawing description in PPML.

FIG. 4D is diagram illustrating an example of drawing description in PPML.

FIG. 4E is diagram illustrating an example of drawing description in PPML.

FIG. 4F is diagram illustrating an example of drawing description in PPML.

FIG. 5 is a diagram illustrating an example of an OBJECT tag.

FIG. 6 is a diagram illustrating an example of a state in which parameters are applied to an object.

FIG. 7 is a diagram illustrating an example of conversion to an independent OBJECT tag.

FIG. 8 is a diagram illustrating an example of a MARK tag.

FIG. 9 is a diagram illustrating an example of a state in which parameters are applied to an object.

FIG. 10 is a diagram illustrating an example of correspondence relation of a parameter obtained after conversion and a parameter obtained before conversion.

FIG. 11 is a diagram illustrating an example of conversion to an independent OBJECT tag.

FIG. 12 is a diagram illustrating an example of a MARK tag.

FIG. 13 is a diagram illustrating an example of a state in which parameters are applied to an object.

FIG. 14 is a diagram illustrating an example of correspondence relation of a parameter obtained after conversion and a parameter obtained before conversion.

FIG. 15 is a diagram illustrating an example of conversion to an independent OBJECT tag.

FIG. 16 is a diagram illustrating an example of a MARK tag.

FIG. 17 is a diagram illustrating an example of a state in which parameters are applied to an object.

FIG. 18 is a diagram illustrating an example of correspondence relation of a parameter obtained after conversion and a parameter obtained before conversion.

FIG. 19 is a diagram illustrating an example of a flowchart according to conversion output processing.

FIG. 20 is a diagram illustrating an example of a flowchart according to PPML script output processing.

FIG. 21 is a diagram illustrating a schematic example of processing by a control unit.

FIG. 22 is a diagram illustrating an example of a PPML script.

FIG. 23 is a diagram illustrating an example of a PPML script.

### DESCRIPTION OF EMBODIMENTS

Hereinafter, the embodiments according to the present invention are described with reference to the accompanying drawings.

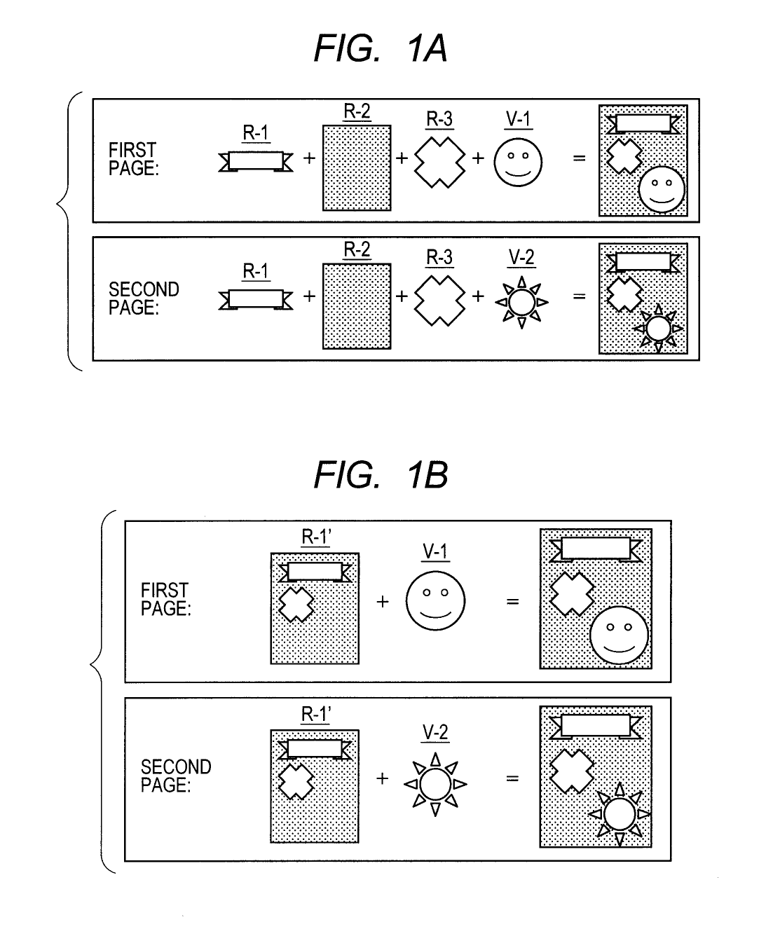

FIGS. 1A and 1B are diagrams illustrating an example of a configuration of Variable Data Printing (VDP) data according to a VDP document. In the VDP document, there exists a plurality of objects (drawing objects, etc) whether or not the objects are fixed (or variable) in a single page. When there are objects that are referred to in each page in the same combinations every time (hereinafter, referred to as “fixed object” as appropriate), and interpretation processing results are held separately, efficiency of processing is low because merge processing is needed to be performed each time the objects are referred to. Accordingly, in the embodiment, when there is such plurality of fixed objects included in a single page, a configuration is employed in which the interpretation processing results can be held in a state where the objects are merged without separation. First, further detailed description is made with reference to FIGS. 1A and 1B.

FIG. 1A illustrates an example of content of VDP data. A first page includes fixed objects R-1, R-2, R-3, and a variable object V-1, and a second includes the fixed objects R-1, R-2, R-3, and a variable object V-2. When such VDP data is processed, an information processing apparatus (computer) performs the merge processing of the fixed object R-1, R-2, and R-3 in both creation of the first page and the second page because the information processing apparatus holds each of the interpretation processing results of the fixed object R-1, R-2, and R-3, separately. That is, when the information processing apparatus processes such VDP data, the information processing apparatus needs to perform the merge processing of the fixed object R-1, R-2, and R-3 twice.

FIG. 1B illustrates an example of content of VDP data different from the VDP data illustrated in FIG. 1A. A final drawing result is substantially the same as the result of the VDP data illustrated in FIG. 1A, however, in the VDP data illustrated in FIG. 1B, a fixed object is defined as a fixed object R-1′ in which the fixed objects R-1, R-2, and R-3 are merged. In this case, the merge processing of the fixed objects is not needed for processing in the first page and second page because the information processing apparatus holds the interpretation processing results as the state of the fixed object R-1′, thereby enhancing a processing speed by one merge processing portion in comparison with the case of FIG. 1A.

Thus, when the VDP data illustrated in FIG. 1A is converted into the VDP data illustrated in FIG. 1B, efficiency of processing according to the VDP data can be enhanced without working over the VDP data processing system. At this time, it is needed to be noted so that the drawing results are not different between before and after conversion. Hereinafter, based on the above-described points, more specific description is made for a method (page description method) in which individually defined objects are merged and defined (or redefined) as a new object to realize optimization of VDP data.

Here, in order to define individually defined objects as a new object that is in a state where the objects are merged, individually defined objects desired to be merge are merged as a single group object first. After that, the group object is defined as a new object. It is noted that, in actual optimization, VDP data may be rewritten based on description method of PDL or new VDP data may be created in order to realize the above-described processing.

In addition, in each object in VDP data, generally, parameters indicating arrangement, scaling, rotation, skew, and clip area, etc. of the object on a page (hereinafter, referred to as “parameter”) are set.

Here, in a parameter, there are cases including a case (1) where a parameter is set individually with respect to each object, a case (2) where a parameter is collectively set with respect to a plurality of objects using a grouping function, and a case (3) where both of the cases (1) and (2) are performed. The way of setting a parameter varies depending on PDL representing VDP data, however, hereinafter, PDL in which the case (3) can be performed is mentioned because the cases (1) and (2) are considered by considering the case (3). Hereinafter, a parameter individually set (applied) to each object is referred to as “individual parameter”, and a parameter set to a group to which objects belong is referred to as “group parameter”.

The information processing apparatus according to the embodiment generates a new individual parameter from an individual parameter and a group parameter by calculation with respect to each object desires to be merged so that the drawing results are not different between before and after optimization. The new individual parameter corresponds to a merged value of the original individual parameter and original group parameter. After that, the information processing apparatus regards a group to which objects belong, which is to be merged and to which the generated new individual parameter is set, as a single group object that does not include a group parameter, and defines the single group object as a new object.

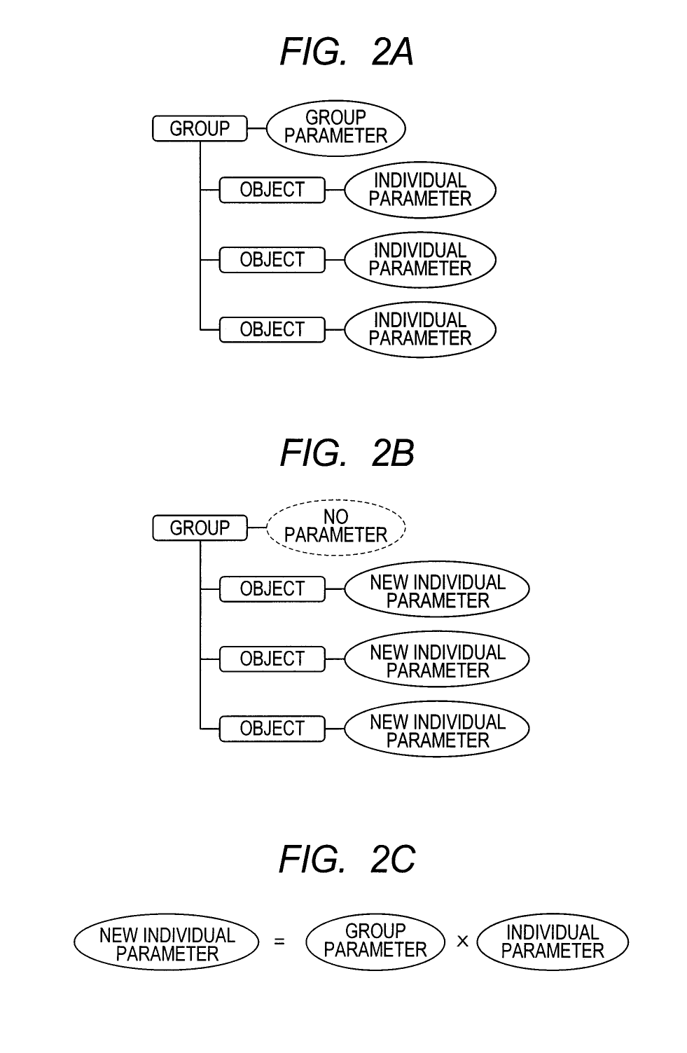

FIGS. 2A and 2B are diagrams conceptually illustrating an individual parameter, a group parameter, and a new individual parameter. FIG. 2A illustrates an example of a structure of VDP data obtained before optimization. An individual parameter is set to each object, furthermore, a group parameter is set to a group of objects. FIG. 2B illustrates an example of a structure of VDP data obtained after optimization. An individual parameter is set to each object, however, a group parameter is not set to a group of objects. A new individual parameter obtained after optimization corresponds to a merged value of an individual parameter and a group parameter obtained before optimization as illustrated in FIG. 2C.

Here, a case where the information processing apparatus performs optimization of PPML data (PPML script) to be used for PPML that is an example of page description language is described as an example.

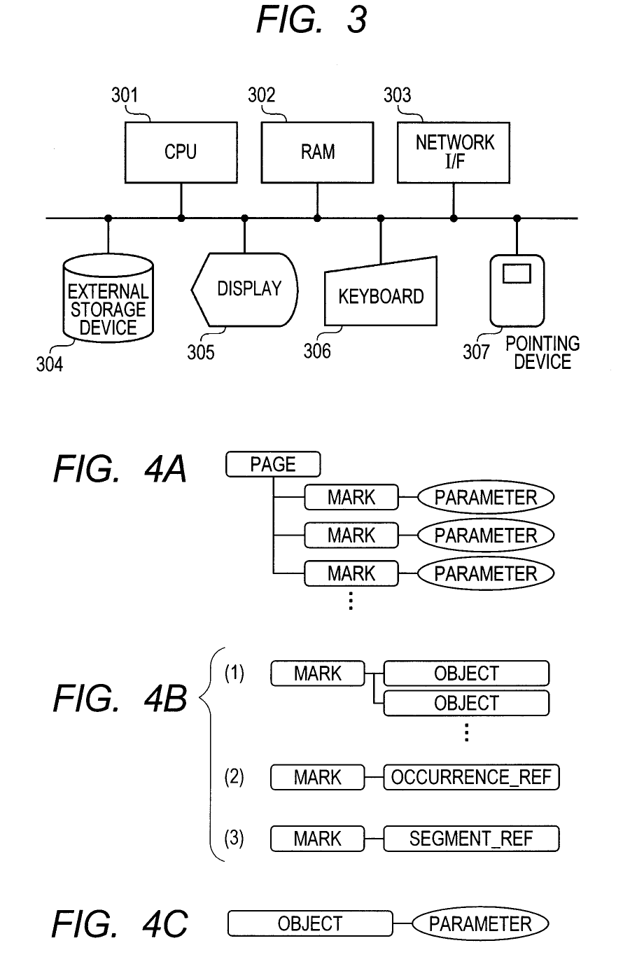

FIG. 3 is a diagram illustrating an example of a hardware configuration of the information processing apparatus. A Central Processing Unit (CPU) 301 performs control of the whole information processing apparatus based on a control program stored in a Random Access Memory (RAM) 302. The RAM 302 is an example of an internal storage unit and stores the control program of the information processing apparatus executed by the CPU 301 and data including document image. A network interface (I/F) 303 performs connection to a network under the control of the CPU 301 and transmits and receives data, etc. An external storage device 304 is a magnetic disk, etc. and stores various data. A display 305 is an example of a display device, and a keyboard 306 and a pointing device 307 including a mouse are examples of an input device.

In the embodiment, the CPU 301 performs processing based on procedures of a program stored in the RAM 302 to realize functions in the information processing apparatus and processing according to a flowchart described later. For example, an application (control unit) is activated by the above-described processing, performs reading and writing of content of data temporarily stored in the RAM 302, and performs reading and writing of the data on the external storage device 304. In addition, for example, the application performs transmission and reception of data through the network interface 303, receives an input from the keyboard 306 and the pointing device 307, and performs display on the display 305.

It is noted that the application uses a function of an Operating System (OS) as necessary when the application performs a specific operation.

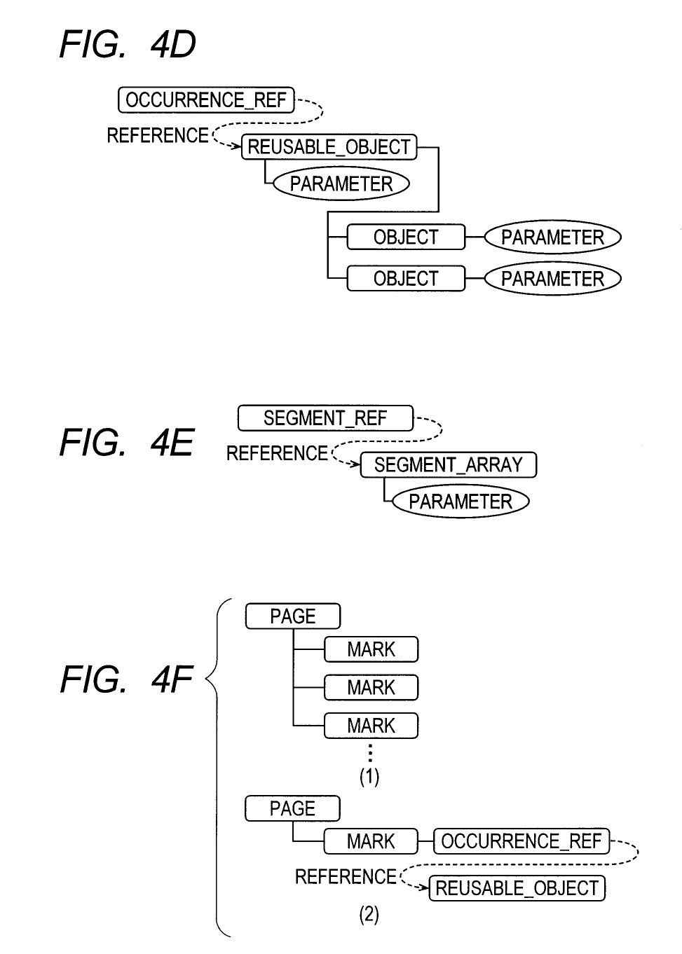

Next, PPML is described. FIGS. 4A to 4F are diagrams illustrating an example of drawing description in PPML.

As illustrated in FIG. 4A, in a page in PPML, a group of drawings is represented by a MARK tag (an example of object information). In each of the MARK tags, parameters are defined that indicate arrangement position, scaling, rotation, skew, and clip area, etc. that are applied to the whole drawing content belonging to each of the MARK tags. In addition, in a MARK tag, as illustrated in FIG. 4B, there are configuration patterns (1) to (3). It is noted that, in a page in PPML, one or more MARK tags are described for each page.

In the (1) of FIG. 4B, a pattern in which there exists one or more OBJECT tags under a MARK tag is illustrated. An OBJECT tag indicates a single object. In addition, as illustrated in FIG. 4C, an OBJECT tag includes parameters indicating arrangement position, scaling, rotation, skew, and clip area, etc. of an object indicated by the OBJECT tag.

In the (2) of FIG. 4B, a pattern in which there exists an OCCURRENCE_REF tag under a MARK tag is illustrated. In an OCCURRENCE_REF tag, as illustrated in FIG. 4D, description can be made in which a group of objects preliminarily defined by a REUSABLE_OBJECT tag (shared information) is referred to. Accordingly, definition and reference of the object can be represented by PPML. There can be one or more OBJECT tags under a REUSABLE_OBJECT tag. A REUSABLE_OBJECT tag includes parameters indicating arrangement position, scaling, rotation, skew, and clip area, etc. that are applied to the whole of the one or more OBJECT tags belonging to the REUSABLE_OBJECT tag.

In the (3) of FIG. 4B, a pattern in which there exists a SEGMENT_REF tag under a MARK tag is illustrated. In a SEGMENT_REF tag, as illustrated in FIG. 4E, description can be made in which an object preliminarily defined by a SEGMENT_ARRAY tag is referred to. Accordingly, definition and reference of the object can be represented by PPML. There is no OBJECT tag under a SEGMENT_ARRAY tag, and a SEGMENT_ARRAY tag itself indicates a single object. A SEGMENT_ARRAY tag includes parameters indicating arrangement position, scaling, rotation, skew, and clip area, etc. that are applied to an object indicated by the SEGMENT_ARRAY tag.

Next, object processing in a PPML data processing system (that may be the information processing apparatus or another computer) is described. When the PPML data processing system detects a REUSABLE_OBJECT tag or a SEGMENT_ARRAY tag, the PPML data processing system stores an analysis processing result of the object indicated by the REUSABLE_OBJECT tag or the SEGMENT_ARRAY tag as an object. After that, a corresponding object is drawn by the patterns of (2) and (3) of FIG. 4B each time a part in which a MARK tag is referred to is detected. As described above, generally, the PPML data processing system deals with an object for each MARK tag unit described in a PPML script that is an example of page description information.

Based on the above-described points, it can be inferred that a plurality of objects indicated by a plurality of MARK tags is indicated as a single object by PPML. Accordingly, it is conceived that a plurality of MARK tags illustrated in (1) of FIG. 4F is converted into a single MARK tag including an OCCURRENCE_REF tag illustrated in (2) of FIG. 4F, and a REUSABLE_OBJECT tag.

Here, as long as each of the MARK tags is converted into one or more OBJECT tags, a single REUSABLE_OBJECT tag in which the MARK tags are merged can be created because a REUSABLE_OBJECT tag can include one or more OBJECT tags in PPML.

Now, a method in which each MARK tag is converted into one or more OBJECT tags is described with reference to configuration patterns of each of the MARK tags illustrated in the (1) to (3) of FIG. 4B. An OBJECT tag is described first.

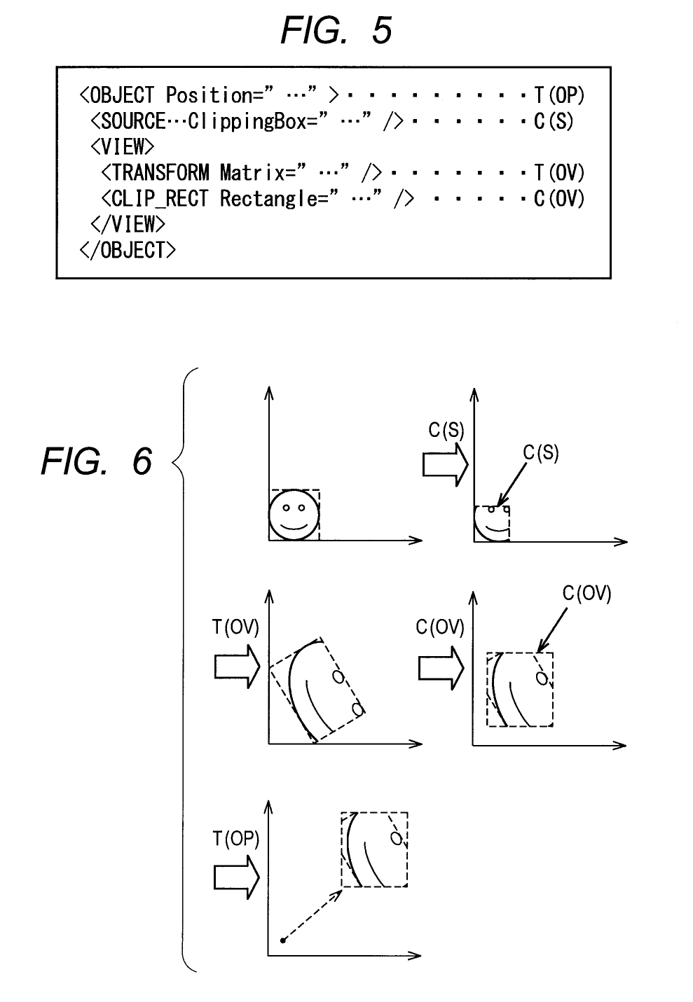

FIG. 5 is a diagram illustrating an example of an OBJECT tag, and a diagram illustrating description of a general format of a single OBJECT tag in an actual PPML script. Each symbol in FIG. 5 is each parameter indicating arrangement position, scaling, rotation, skew, and clip area, etc. of an object, and the parameters are described below.

C (S): a clip area to an object specified by a SOURCE tag

T (OV): a transform matrix applied to the object clipped by C (S)
C (OV): a clip area to the object transformed by T (OV)
T (OP): a transform matrix for determining an original position of the object (the transform matrix allows only translation)

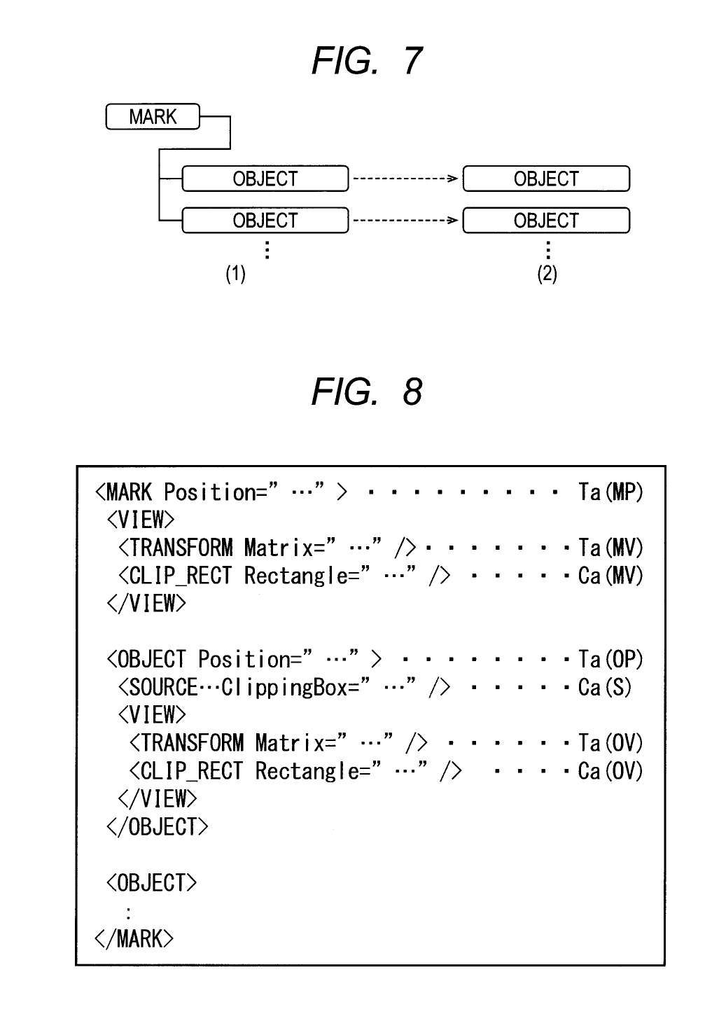

The transform and clipping are performed to a single object indicated by an OBJECT tag in order of C (S), T (OV), C (OV), and T (OP). FIG. 6 is a diagram illustrating an example of a state in which the parameters are applied to an object.

Next, a method in which a MARK tag is converted into one or more OBJECT tags is described with reference to a configuration pattern of the MARK tag illustrated in the (1) of FIG. 4B. In the embodiment, for example, each of the OBJECT tags in the MARK tag illustrated in (1) of FIG. 7 (the (1) of FIG. 4B) is converted into independent OBJECT tags illustrated in (2) of FIG. 7, respectively. An independent OBJECT tag is an OBJECT tag that is independent of the parameter of the MARK tag.

FIG. 8 is a diagram illustrating an example of a MARK tag, and a diagram illustrating description of a general format of a Mark tag of the configuration pattern illustrated in the (1) of FIG. 4B in an actual PPML script. It is noted that description is made in which a first OBJECT tag in the MARK tags can be converted into a single OBJECT tag that is independent of parameters of the MARK tags, and description related to conversion of a second and subsequent OBJECT tags are omitted because the conversion of the second and subsequent OBJECT tags is similar to the conversion of the first OBJECT tag. Each symbol in FIG. 8 is each parameter indicating arrangement position, scaling, rotation, skew, and clip area, etc. of an object, the parameters are described below.

Ca (S): a clip area to an object specified by a SOURCE tag

Ta (OV): a transform matrix applied to the object clipped by Ca (S)
Ca (OV): a clip area to the object transformed by Ta (OV)
Ta (OP): a transform matrix for determining an original position of the object (the transform matrix allows only translation)
Ta (MV): a transform matrix applied to all OBJECT tags included in a MARK tag
Ca (MV): a clip area to all of the OBJECT tags included in the MARK tag
Ta (MP): a transform matrix for determining an original position of the whole MARK tag (the transform matrix allows only translation)

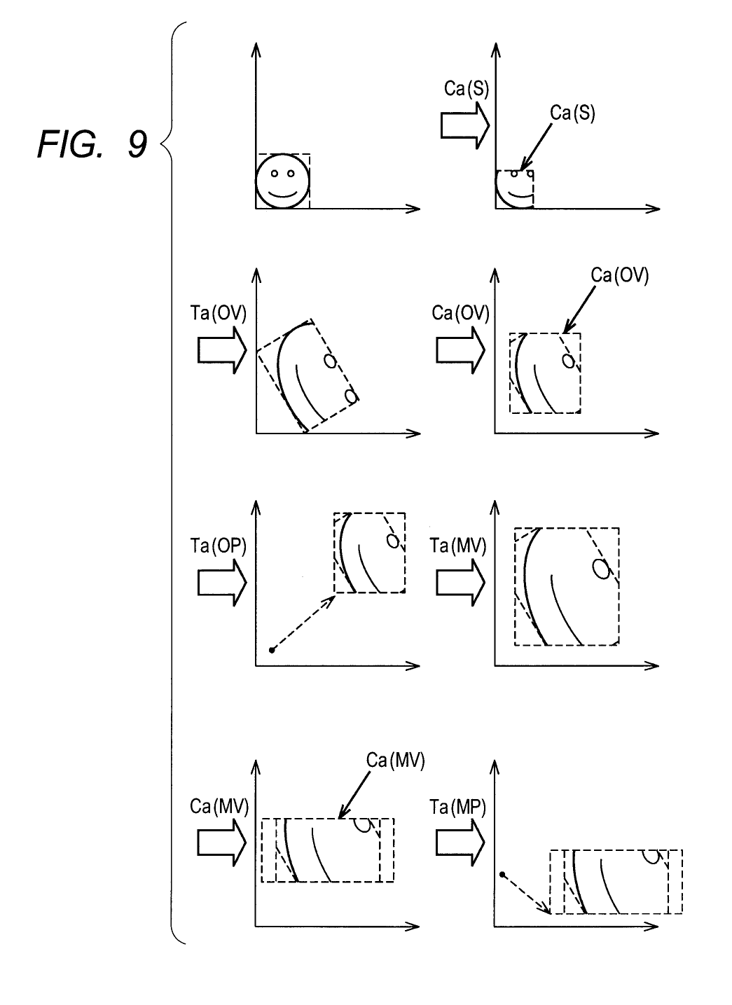

The transform and clipping are applied to a single object indicated by an OBJECT tag in order of Ca (S), Ta (OV), Ca (OV), Ta (OP), Ta (MV), Ca (MV), and Ta (MP). FIG. 9 is a diagram illustrating an example of a state in which the above-described parameters are applied to an object. In the embodiment, the information processing apparatus obtains each of the parameters of FIG. 5 from the above-described parameters.

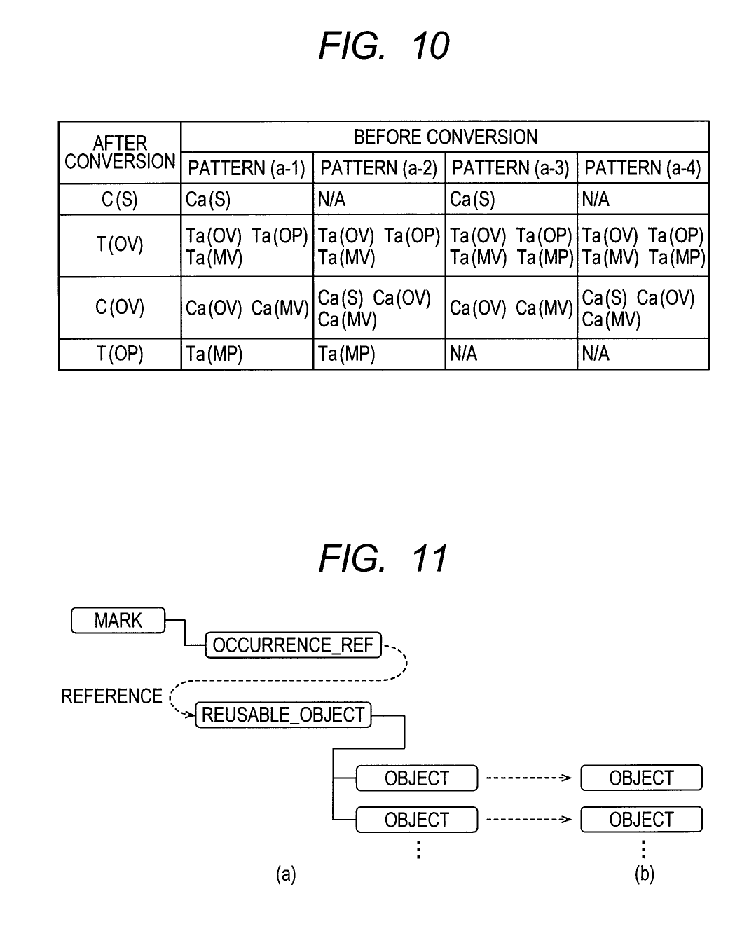

FIG. 10 is a diagram illustrating an example of correspondence relation of each of the parameters of FIG. 5 (parameters obtained after conversion) and each of the parameters of FIG. 8 (parameters obtained before conversion). As illustrated in FIG. 10, it is conceived that there are four patterns of the correspondence relation of each of the parameters obtained after conversion and each of the parameters obtained before conversion. In each of the patterns, the conversion formulas are as follows.

<Pattern (a-1)>

### C(S)=Ca(S)

T(OV)=Ta(oV)×Ta(OP)×Ta(MV)

C(OV)=shared portion between Ca(MV) and Ca(OV)×Ta(OP)×Ta(MV)

T(OP)=Ta(MP)

<Pattern (a-2)>

C(S)=(no clip area)

T(OV)=Ta(oV)×Ta(OP)×Ta(MV)

C(OV)=shared portion between Ca(MV), Ca(OV)×Ta(OP)×Ta(MV), and Ca(S)×Ta(OV)×Ta(OP)×Ta(MV)

T(OP)=Ta(MP)

<Pattern (a-3)>

C(S)=Ca(S)

T(OV)=Ta(OV)×Ta(OP)×Ta(MV)×Ta(MP)

C(OV)=shared portion between Ca(MV)×Ta(MP) and Ca (OV)×Ta(OP)×Ta(MV)×Ta(MP)

T(OP)=(identity transform matrix)

<Pattern (a-4)>

C(S)=(no clip area)

T(OV)=Ta(OV)×Ta(OP)×Ta(MV)×Ta(MP)

C(OV)=shared portion between Ca(MV)×Ta(MP), Ca (OV)×Ta(OP)×Ta(MV)×Ta(MP), and Ca(S)×Ta(OV)×Ta(OP)×Ta(MV)×Ta(MP)

T(OP)=(identity transform matrix)

In the embodiment, the information processing apparatus calculates a new parameter for each object using any of the above-described patterns of calculation formulas (conversion formulas for an OBJECT tag). Thus, the MARK tag of the configuration pattern illustrated in the (1) of FIG. 4B can be converted into one or more OBJECT tags that are independent of the parameter of the MARK tag.

Next, a method in which a MARK tag is converted into one or more OBJECT tags is described with reference to a configuration pattern of the MARK tag illustrated in the (2) of FIG. 4B. In the embodiment, for example, each OBJECT tag in a REUSABLE_OBJECT tag illustrated in (a) of FIG. 11 (FIG. 4D) is converted into independent OBJECT tags illustrated in (b) of FIG. 11, respectively. The independent OBJECT tag is an OBJECT tag that is independent of the parameters of the MARK tag, the OCCURRENCE REF_tag, and the REUSABLE_OBJECT tag.

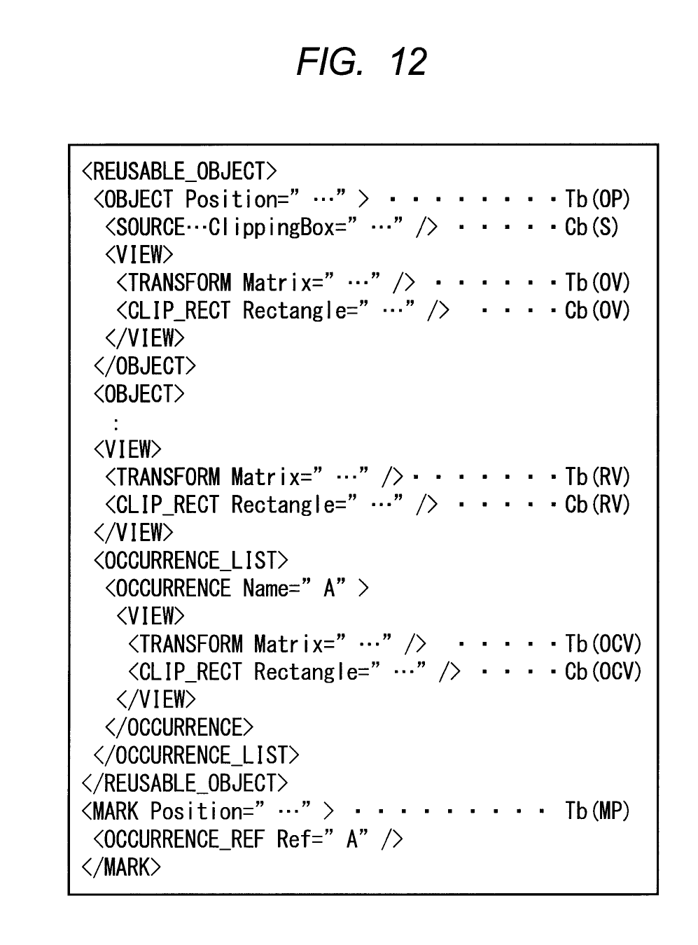

FIG. 12 is a diagram illustrating an example of a MARK tag, and a diagram illustrating description of a general format of a Mark tag of the configuration pattern illustrated in the (2) of FIG. 4B in an actual PPML script. Each symbol in FIG. 12 is each parameter indicating arrangement position, scaling, rotation, skew, and clip area, etc. of an object, the parameters are described below.

Cb (S): a clip area to an object specified by a SOURCE tag

Tb (OV): a transform matrix applied to the object clipped by Cb (S)
Cb (OV): a clip area to the object transformed by Tb (OV)
Tb (OP): a transform matrix for determining an original position of the object (the transform matrix allows only translation)
Tb (RV): a transform matrix applied to all OBJECT tags included in a REUSABLE_OBJECT tag
Cb (RV): a clip area to all of the OBJECT tags included in the REUSABLE_OBJECT tag
Tb (OCV): a transform matrix applied to an OCCURRENCE tag
Cb (OCV): a clip area to the OCCURRENCE tag
Tb (MP): a transform matrix for determining an original position of the whole MARK tag (the transform matrix allows only translation)

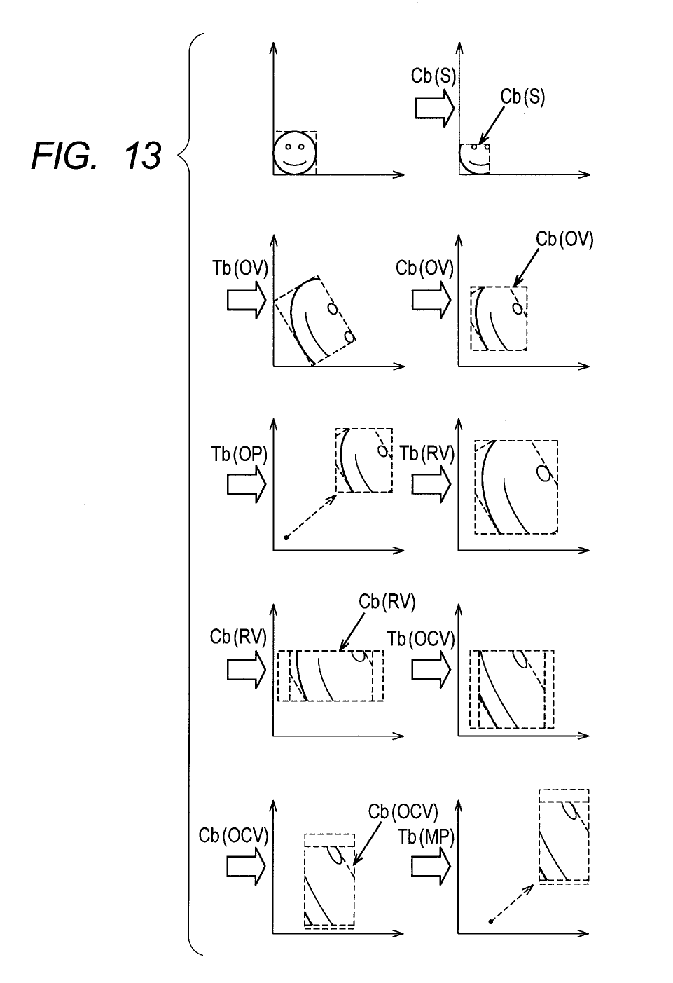

The transform and clipping are applied to a single object indicated by an OBJECT tag in order of Cb (S), Tb (OV), Cb (OV), Tb (OP), Tb (RV), Cb (RV), Tb (OCV), Cb (OCV), and Tb (MP). FIG. 13 is a diagram illustrating an example of a state in which the above-described parameters are applied to an object. In the embodiment, the information processing apparatus obtains each of the parameters of FIG. 5 from the above-described parameters.

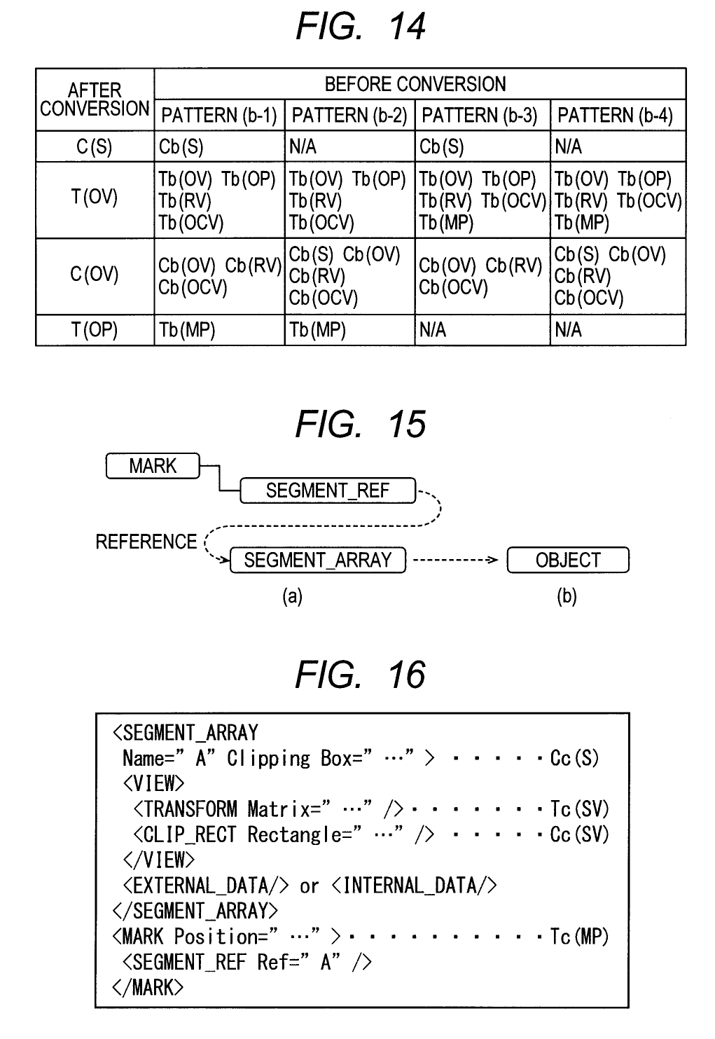

FIG. 14 is a diagram illustrating an example of correspondence relation of each of the parameters of FIG. 5 (parameters obtained after conversion) and each of the parameters of FIG. 12 (parameters obtained before conversion). As illustrated in FIG. 14, it is conceived that there are four patterns of the correspondence relation of each of the parameters obtained after conversion and each of the parameters obtained before conversion. In each of the patterns, the conversion formulas are as follows.

<Pattern (b-1)>

C(S)=Cb(S)

T(OV)=Tb(OV)×Tb(OP)×Tb(RV)×Tb(OCV)

C(OV)=shared portion between Cb(OCV), Cb(RV)×Tb(OCV), and Cb(OV)×Tb(OP)×Tb(RV)×Tb(OCV)

T(OP)=Tb(MP)

<Pattern (b-2)>

C(S)=(no clip area)

T(OV)=Tb(OV)×Tb(OP)×Tb(RV)×Tb(OCV)

C(OV)=shared portion between Cb(OCV), Cb(RV)×Tb(OCV), Cb(OV)×Tb(OP)×Tb(RV)×Tb(OCV), and Cb(S)×Tb(OV)×Tb(OP)×Tb(RV)×Tb(OCV)

T(OP)=Tb(MP)

<Pattern (b-3)>

C(S)=Cb(S)

T(OV)=Tb(OV)×Tb(OP)×Tb(RV)×Tb(OCV)×Tb(MP)

C(OV)=shared portion between Cb(OCV)×Tb(MP), Cb(RV)×Tb(OCV)×Tb(MP), and Cb(OV)×Tb(OP)×Tb(RV)×Tb(OCV)×Tb(MP)

T(OP)=(identity transform matrix)

<Pattern (b-4)>

C(S)=(no clip area)

T(OV)=Tb(OV)×Tb(OP)×Tb(RV)×Tb(OCV)×Tb(MP)

C(OV)=shared portion between Cb(OCV)×Tb(MP), Cb(RV)×Tb(OCV)×Tb(MP), Cb(OV)×Tb(OP)×Tb(RV)×Tb(OCV)×Tb(MP), and Cb(S)×Tb(OV)×Tb(OP)×Tb(RV)×Tb(OCV)×Tb(MP)

T(OP)=(identity transform matrix)

In the embodiment, the information processing apparatus calculates a new parameter for each object using any of the above-described patterns of calculation formulas (conversion formulas for an OCCURRENCE_REF tag). Thus, the MARK tag of the configuration pattern illustrated in the (2) of FIG. 4B can be converted into one or more OBJECT tags that are independent of the parameters of the MARK tag, the OCCURRENCE_REF tag, and the REUSABLE_OBJECT tag.

Next, a method in which a MARK tag is converted into an OBJECT tags is described with reference to a configuration pattern of the MARK tag illustrated in the (3) of FIG. 4B. In the embodiment, for example, a SEGMENT_ARRAY tag illustrated in (a) of FIG. 15 (FIG. 4E) is converted into independent OBJECT tags illustrated in (b) of FIG. 15. The independent OBJECT tag is an OBJECT tag that is independent of the parameters of the MARK tag and the SEGMENT_ARRAY tag.

FIG. 16 is a diagram illustrating an example of a MARK tag, and a diagram illustrating description of a general format of a Mark tag of the configuration pattern illustrated in the (3) of FIG. 4B in an actual PPML script. Each symbol in FIG. 16 is each parameter indicating arrangement position, scaling, rotation, skew, and clip area, etc. of an object, the parameters are described below.

Cc (S): a clip area to an object specified by a SEGMENT_ARRAY tag
Tc (SV): a transform matrix applied to the object clipped by Cc (S)
Cc (SV): a clip area to the object transformed by Tc (SV)
Tc (MP): a transform matrix for determining an original position of the whole MARK tag (the transform matrix allows only translation)

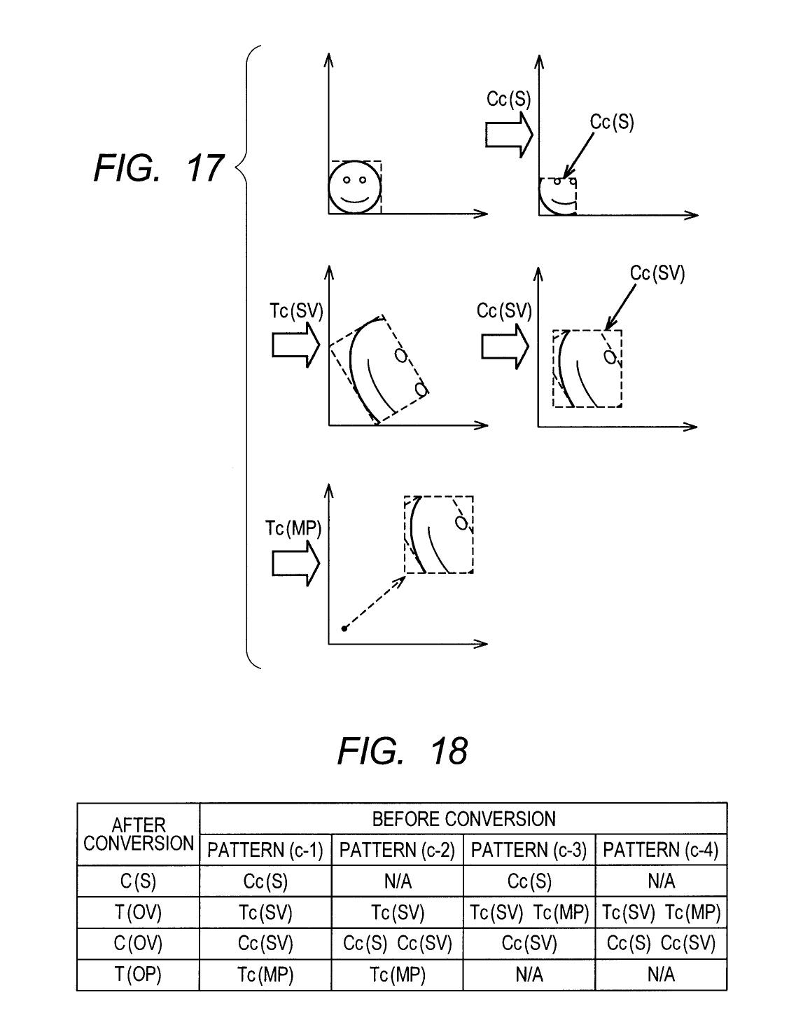

The transform and clipping are applied to a single object indicated by a SEGMENT_ARRAY tag in order of Cc (S), Tc (SV), Cc (SV), and Tc (MP). FIG. 17 is a diagram illustrating an example of a state in which the above-described parameters are applied to an object. In the embodiment, the information processing apparatus obtains each of the parameters of FIG. 5 from the above-described parameters.

FIG. 18 is a diagram illustrating an example of correspondence relation of each of the parameters of FIG. 5 (parameters obtained after conversion) and each of the parameters of FIG. 16 (parameters obtained before conversion). As illustrated in FIG. 18, it is conceived that there are four patterns of the correspondence relation of each of the parameters obtained after conversion and each of the parameters obtained before conversion. In each of the patterns, the conversion formulas are as follows.

<Pattern (c-1)>

C(S)=Cc(S)

T(OV)=Tc(SV)

C(OV)=Cc(SV)

T(OP)=Tc(MP)

<Pattern (c-2)>

C(S)=(no clip area)

T(OV)=Tc(SV)

C(OV)=shared portion between Cc(SV) and Cc(S)×Tc(SV)

T(OP)=Tc(MP)

<Pattern (c-3)>

C(S)=Cc(S)

T(OV)=To(SV)×Tc(MP)

C(OV)=Cc(SV)×Tc(MP)

T(OP)=(identity transform matrix)

<Pattern (c-4)>

C(S)=(no clip area)

T(OV)=Tc(SV)×Tc(MP)

C(OV)=shared portion between Cc(SV)×Tc(MP) and Cc(S)×Tc(SV)×Tc(MP)

T(OP)=(identity transform matrix)

In the embodiment, the information processing apparatus calculates a new parameter for each object using any of the above-described patterns of calculation formulas (conversion formulas for an SEGMENT_REF tag). Thus, the MARK tag of the configuration pattern illustrated in the (3) of FIG. 4B can be converted into one or more OBJECT tags that are independent of the parameters of the MARK tag and the SEGMENT_ARRAY tag.

In this way, in all of the configuration patterns of the MARK tags, the information processing apparatus converts the MARK tag into one or more OBJECT tags using the above-described calculation formulas. After that, the information processing apparatus creates a REUSABLE_OBJECT tag into which the one or more converted OBJECT tags are merged. After that, the information processing apparatus defines the single REUSABLE_OBJECT tag, that is, a new object, from one or more MARK tags.

It is noted that, in the embodiment, T (OV) that is an example of a transform parameter for performing at least one of scaling, rotation, translation, and skew of an object and C (OV) that is an example of a clipping parameter for performing clipping of an object are calculated. However, the embodiment is not limited thereto, and one of T (OV) and C (OV) may be calculated.

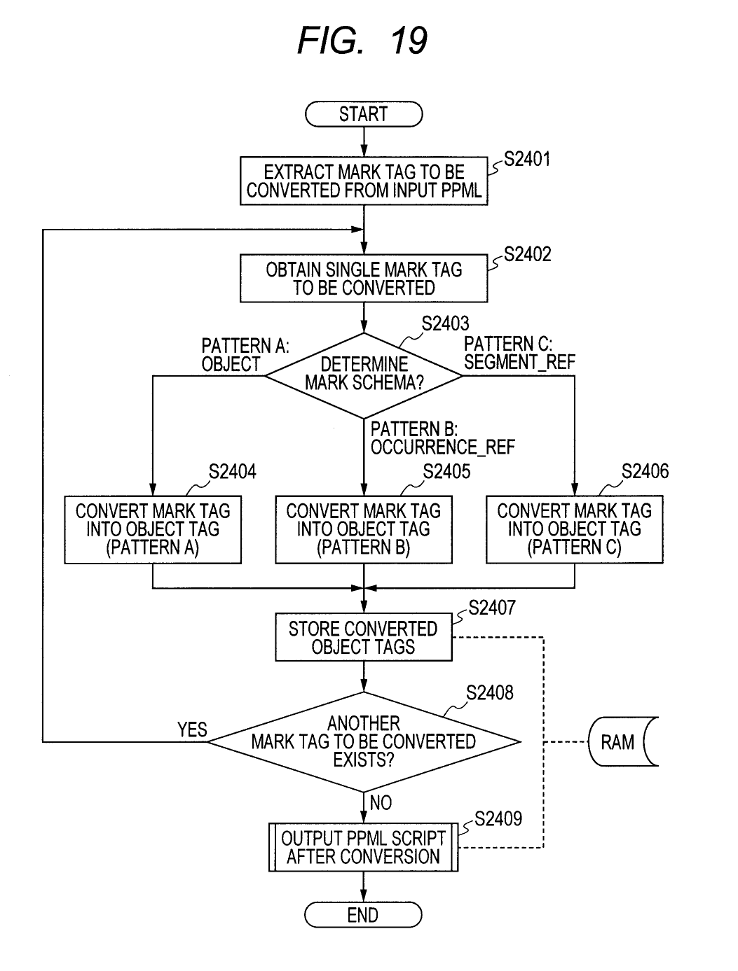

FIG. 19 is a diagram illustrating an example of a flowchart according to processing for outputting a PPML script in which one or more MARK tags in the PPML script are converted into a single MARK tag (conversion output processing). It is noted that the flowchart is realized when the CPU 301 reads a program related to the processing from a memory and executes the program.

First, a control unit of the information processing apparatus extracts a MARK tag to be converted from the PPML script (S2401). It is noted that an arbitrary method such as a method in which an inquiry is performed to a user each time a MARK tag is detected can be employed as an extraction method. After that, the control unit obtains the single MARK tag to be converted (S2402) and determines that a structure of the MARK tag and structures under the MARK tag (S2403). That is, the control unit checks subsidiary element tags of the MARK tag to perform the determination. More specifically, when the control unit determines that there exists an OBJECT tag in the subsidiary element tags, “pattern (a): OBJECT” is determined. In addition, when the control unit determines that there exists an OCCURRENCE_REF tag in the subsidiary element tags, “pattern (b): OCCURRENCE_REF” is determined. In addition, when the control unit determines that there exists a SEGMENT_REF tag in the subsidiary element tags, “pattern (c): SEGMENT_REF” is determined.

After that, the control unit converts the MARK tag into one or more OBJECT tags using the above-described calculation formulas depending on each patterns of the structure of MARK tag and the patterns under the MARK tag (S2404, S2405, and S2406). After that, the control unit stores scripts of the one or more converted OBJECT tags in the RAM 302 (S2407), and determines whether or not another MARK tag to be converted exists (S2408). At that time, the control unit performs processing of S2402 when the control unit determines that another MARK tag to be converted exists, on the other hand, the control unit performs processing of S2409 when the control unit determines that another MARK tag to be converted does not exist. In S2409, the control unit takes out the stored scripts of the one or more OBJECT tags from the RAM 302 and outputs a PPML script in which the taken-out scripts of the one or more OBJECT tag are merged.

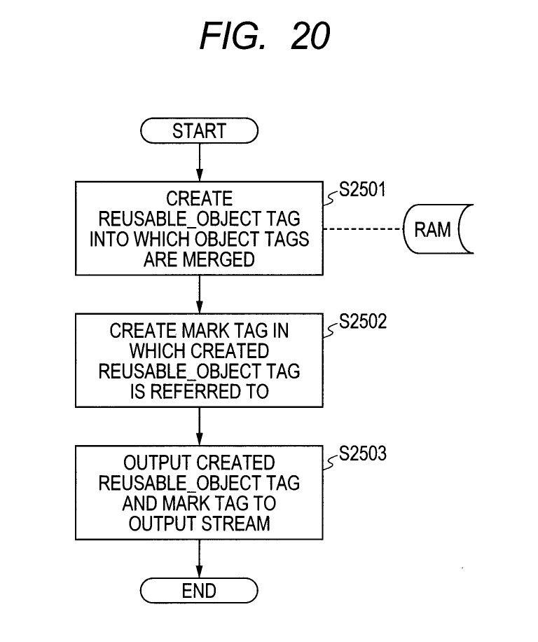

FIG. 20 is a diagram illustrating an example of a flowchart according to the processing of S2409 in FIG. 19 (PPML script output processing after conversion).

First, the control unit creates a script in which the scripts of the one or more OBJECT tags taken out from the RAM 302 are merged into a single REUSABLE_OBJECT tag (S2501). After that, the control unit creates a script of a MARK tag in which the created REUSABLE_OBJECT tag is referred to (S2502) and outputs the created script to a specified output destination (S2503).

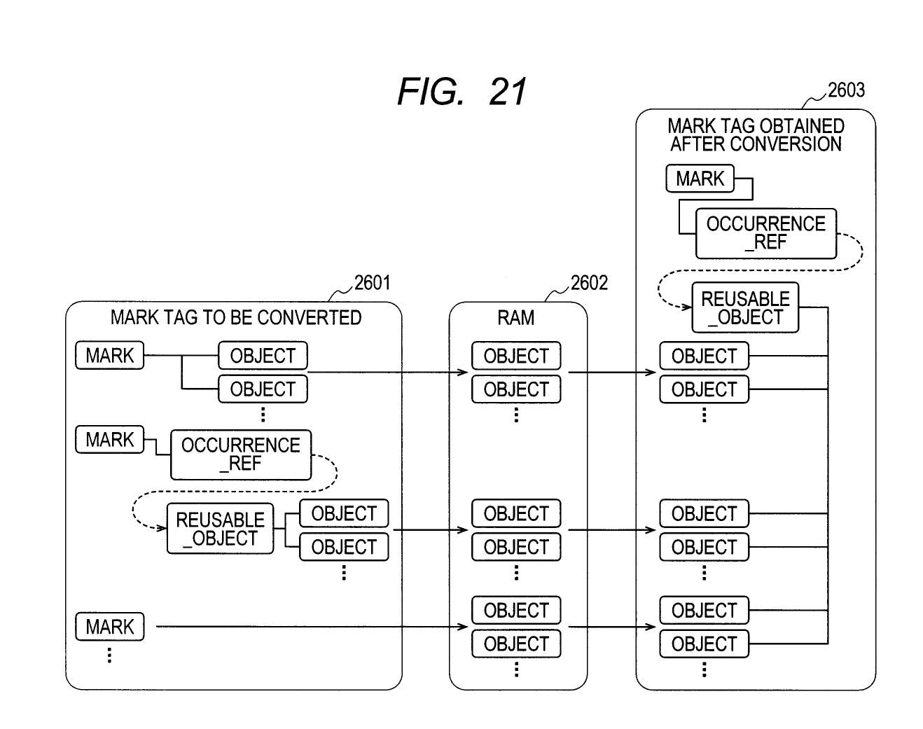

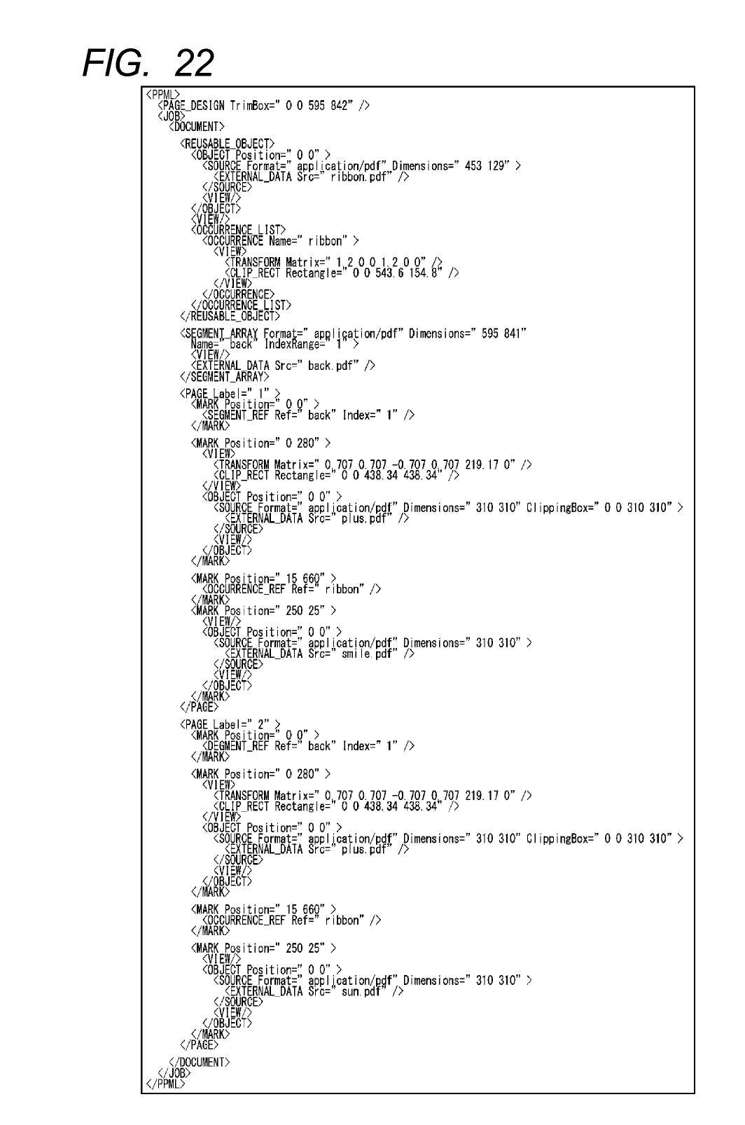

FIG. 21 is a diagram illustrating a schematic example of processing by the control unit illustrated in FIGS. 19 and 20. One or more MARK tags to be converted are converted into one or more OBJECT tags by processing of S2401 to S2408 and stored in the RAM 302 as a script. After that, by processing of S2409, a MARK tag obtained after conversion in which scripts of the converted OBJECT tags are merged is created.

FIG. 22 is a diagram illustrating an example of a PPML script. The PPML script represents the VDP data of FIG. 1A. In the PPML script, each of the R-1, R-2, R-3, V-1, and V-2 of FIG. 1A is represented by a MARK tag. In the fixed objects, the R-1 is represented by the MARK tag of the configuration pattern in the (2) of FIG. 4B, the R-2 is represented by the MARK tag of the configuration pattern in the (3) of FIG. 4B, and the R-3 is represented by the MARK tag of the configuration pattern in the (1) of FIG. 4B.

In the embodiment, the information processing apparatus converts the PPML script of FIG. 22 into a PPML script in which the fixed object R-1, R-2, and R-3 are merged and defined as a single fixed object. First, in the R-1, the information processing apparatus employs, for example, the pattern b-1 of FIG. 14 as correspondence relation between each parameters obtained before conversion and after conversion, calculates each of the parameters obtained after conversion using a calculation formula compatible with the pattern b-1, and converts each of the calculated parameters into an OBJECT tag. Such processing corresponds to the processing of S2405 in the flowchart of FIG. 19. Similarly, in the R-2, the information processing apparatus employs, for example, the pattern c-1 of FIG. 18, calculates each of the parameters obtained after conversion using a calculation formula compatible with the pattern c-1, and converts each of the calculated parameters into an OBJECT tag. Such processing corresponds to the processing of S2406 in the flowchart of FIG. 19. In addition, similarly, in the R-3, the information processing apparatus employs, for example, the pattern a-1 of FIG. 10, calculates each of the parameters obtained after conversion using a calculation formula compatible with the pattern a-1, and converts each of the calculated parameters into an OBJECT tag. Such processing corresponds to the processing of S2404 in the flowchart of FIG. 19.

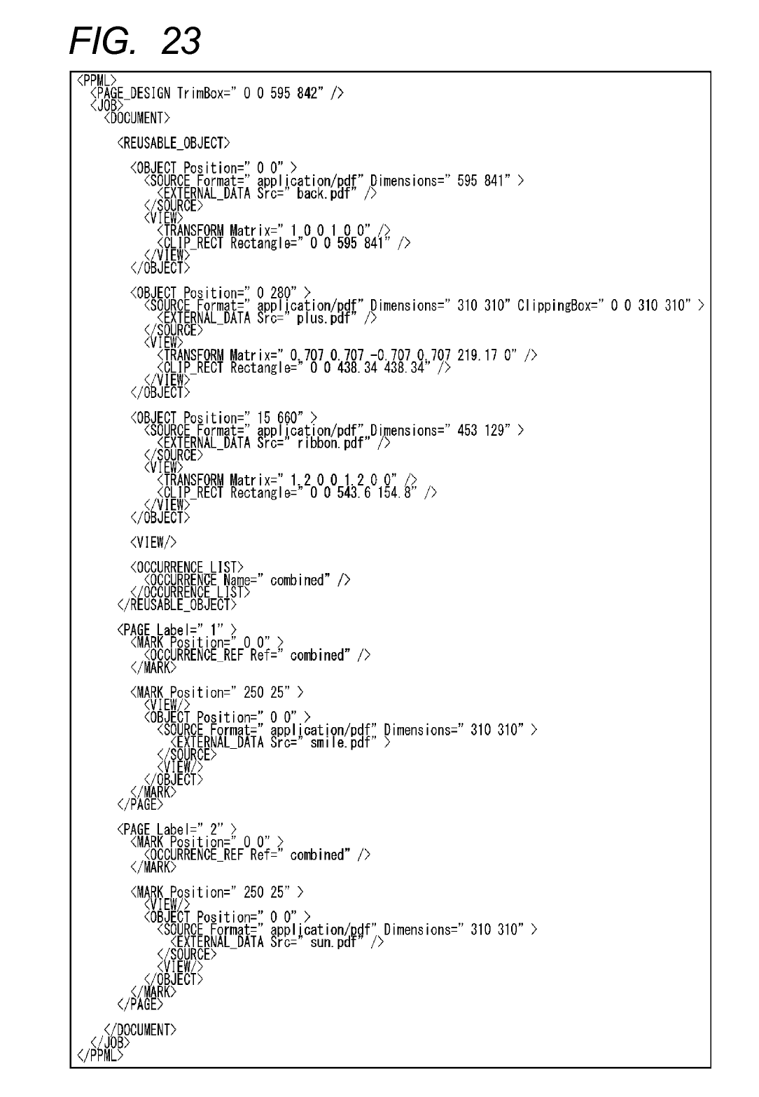

The information processing apparatus merges the three OBJECT tags obtained as described above into a REUSABLE_OBJECT tag by the processing illustrated in the flowchart of FIG. 20 and defines the REUSABLE_OBJECT tag as a single new object to convert the three OBJECT tags into a target PPML script. FIG. 23 is a diagram illustrating an example of the PPML script that is obtained after the PPML script illustrated in FIG. 22 is converted.

According to the embodiment, a plurality of objects is merged and can be defined as a single new object. By utilizing the processing, application becomes available such as reuse in which background objects are merged and reuse in which all objects in a page are merged. In addition, it may be possible that redundancy of VDP data is reduced and data size is decreased because an original plurality of objects are represented so as to be merged. When data size can be decreased, a transfer time of VDP data to the VDP data processing system can be reduced. In addition, in a processing speed of the VDP data processing system, an increase of the processing speed can be expected because a pause time, processing for merging each object, and an access amount of separately-held objects, etc. are reduced due to reduction of the redundancy of VDP data.

According to the embodiment, efficiency of processing for dealing with an object provided to a plurality of pages in common can be further enhanced.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-158821, filed Jul. 13, 2010, which is hereby incorporated by reference herein in its entirety.

1. An information processing apparatus comprising:
a calculation unit configured to calculate, for each object, a parameter from page description information that describes a plurality of pieces of object information each defining a group parameter applied to a group to which an object provided to a plurality of pages in common belongs and defining an individual parameter applied to the object, wherein the group parameter and the individual parameter are merged into the parameter; and
a generation unit configured to generate shared information defining the parameter calculated by the calculation unit and generate the page description information in which the shared information is referred to.

2. The information processing apparatus according to claim 1, wherein the calculation unit calculates, for each object, the parameter in the form of (i) a transform parameter for performing at least one of scaling of the object, rotation of the object, translation of the object and skew of the object, and (ii) a clipping parameter for performing clipping of the object.

3. The information processing apparatus according to claim 1, wherein the page description information is described with page description language used for Variable Data Printing, and
wherein the generation unit generates the shared information and describes a single piece of object information in which the shared information is referred to, for each of the pages, to generate the page description information in which a definition of a fixed object is changed in the page description language and in which the shared information is referred to for each of the pages.

4. The information processing apparatus according to claim 3, wherein the page description language is Personalized Print Markup Language (PPML).

5. The information processing apparatus according to claim 4, wherein each of the plurality of pieces of object information is indicated by a MARK tag, and the shared information is indicated by a REUSABLE_OBJECT tag.

6. The information processing apparatus according to claim 5, wherein the calculation unit calculates the parameter based on a conversion formula preliminarily defined for an OBJECT tag, when the calculation unit determines that a MARK tag provided with the OBJECT tag is included in the page description information.

7. The information processing apparatus according to claim 5, wherein the calculation unit calculates the parameter based on a conversion formula preliminarily defined for an OCCURRENCE_REF tag when the calculation unit determines that a MARK tag provided with the OCCURRENCE_REF tag is included in the page description information.

8. The information processing apparatus according to claim 5, wherein the calculation unit calculates the parameter based on a conversion formula preliminarily defined for a SEGMENT_REF tag when the calculation unit determines that a MARK tag provided with the SEGMENT_REF tag is included in the page description information.

9. An information processing method comprising:
calculating, for each object, a parameter from page description information that describes a plurality of pieces of object information each defining a group parameter applied to a group to which an object provided to a plurality of pages in common belongs and defining an individual parameter applied to the object, wherein the group parameter and the individual parameter are merged into the parameter; and
generating shared information defining the calculated parameter and generating the page description information in which the shared information is referred to.

10. A non-transitory computer-readable storage medium storing a computer program for causing a computer to execute:
a calculate code for calculating, for each object, a parameter from page description information that describes a plurality of pieces of object information each defining a group parameter applied to a group to which an object provided to a plurality of pages in common belongs and defining an individual parameter applied to the object, wherein the group parameter and the individual parameter are merged into the parameter; and
a generating code for generating shared information defining the calculated parameter and generating the page description information in which the shared information is referred to.
